(19) United States
(12) Patent Application Publication
(10) Pub. No.: US 2015/0175332 A1
(43) Pub. Date: Jun. 25, 2015

(54) Inflatable packaging and method for realizing thereof

(71) Applicant: Giuseppe DAINOTTI, Santo Stefano di Camastra (ME) (IT)

(72) Inventor: Giuseppe Dainotti, Santo Stefano di Camastra (ME) (IT)

(21) Appl. No.: 14/417,478

(22) PCT Filed: Jul. 30, 2013
(86) PCT No.: PCT/IB2013/056256

§ 371 Date: Jan. 26, 2015

(30) Foreign Application Priority Data
Jul. 30, 2012 (IT) EN2012A000004

(51) Int. Cl. B65D 81/05; B29C 65/18; B32B 7/14; B32B 3/04; B32B 7/04

(52) U.S. Cl. CPC B65D 81/05; B32B 3/04; B32B 7/04; B32B 7/14; B29C 65/18; B65D 2581/055; B32B 2439/00; B29K 2023/065

(57) ABSTRACT

An inflatable packaging includes a flexible laminar element having at least one pair of reciprocally superimposed layers divided into a plurality of chambers adapted to be filled with a filling fluid and elements fluidically connecting the chambers with each other, at least one chamber being provided with a inlet adapted to be connected to external lines feeding the filling fluid and allowing the inflation of all the chambers through the inlet. A method of producing the above packaging is also disclosed.

### TECHNICAL FIELD

The present invention is generally suitable for the technical field of packaging and is particularly directed to an inflatable packaging with adjustable plan size. The invention is also directed to a method for realizing such an inflatable packaging.

### STATE OF THE ART

Several types of inflatable and flexible packagings are known which are adapted to be wrapped around one or more objects to protect them during transporting.

Generally, inflatable packaging are made of a pair of laminar layers in a polymeric material, such as polyethylene, polyamide or the like, selected in function of the uses, mutually superimposed and joined along the edges, usually by heat sealing.

The two superimposed layers can be possibly obtained starting from a single sheet folded so as to define two tiles.

Moreover, the two layers can optionally be heat-sealed at of one or more internal areas so as to be divided into a plurality of chambers arranged in a pattern of mutually orthogonal rows and columns designed to be filled with a cushioning filling fluid, almost air.

However, this last type of packaging, while presenting advantageous compared to packagings consisting of a single air chamber as being provided with greater flexibility and adaptability to the shape of the products to be wrapped, has obvious drawbacks. In particular, the main drawbacks of these known packages are related to the fact that they are pre-shaped and pre-filled by means of special systems of air insufflation and can not be inflated only at the time of their positioning around the product to be protected.

Consequently, these packagings involve high costs both for their warehouse storage and for transport, since their volume is almost completely defined by air or other filling fluid (also up to 95% of the whole volume), making the product with a low cost-effectiveness and low eco-friendly.

A further drawback is due to the need to operate specific machinery and equipment for realizing them in situ, only possible for large companies or with significant starting investment costs, which become unaffordable for small users.

Not least, the substantial impossibility to shape the packaging according to the specific shape of the products to be protected causes such packaging to be not suitable to be always wrapped in an appropriate manner around the objects, often leaving exposed areas which represent zones of risk for possible damages.

Furthermore, it is not always possible to block the products in an appropriate manner within the transport container.

In other cases it is also possible to use a packaging having size greater than necessary, with unnecessary additional costs.

### SCOPE OF THE INVENTION

An object of the invention is to overcome the above drawbacks, providing an inflatable packaging with high efficiency and relative cost-effectiveness.

A particular object is to provide an inflatable packaging with reduced costs and encumbrance during both warehouse storing and transporting, allowing considerable advantages also for environment compatibility.

Yet another object is to realize an inflatable packaging which could be inflated in a simple manner and by high available means even only just before its wrapping around the products to be protected or also after this step to be sold in a not inflated configuration and to be made also available through small stores.

A further object is to provide an inflatable packaging that could be sized and shaped according to the specific products around which it must be wrapped, to ensure the maximum protection and stability thereof both in the case in which the product is to be inserted in a transporting container that when the packaging is intended to be used without using a further container.

Yet another particular object is to provide an inflatable packaging that could be realized by simple equipment and without large initial investment cost.

Not the last object of the present invention is to provide a method for realizing said inflatable packaging which is particularly simple, rapid and economical.

These objects, as well as others that will become more apparent hereinafter, are obtained by an inflatable packaging that, according to claim 1, comprises a flexible laminar element having at least one pair of mutually superimposed layers divided into a plurality of chambers adapted to be filled with a filling fluid.

The packaging is characterized by comprising means for the mutual fluid connection of said chambers, at least one chamber being provided which has an inlet connectable to external means for feeding said filling fluid to allow the inflation of all chambers of said plurality through said input.

Thanks to this features, the packaging could be realized, stored in a warehouse and transported to the point of use in non-inflated condition, i.e. flat or wrapped in rolls having reduced overall dimensions compared to similar packagings, for equal size.

Further, in this way the final volume of the packaging may be defined by the same user by adjusting the amount of fluid introduced during the use.

Suitably, said connecting means may comprise a plurality of ducts adapted to put in communication the mutually adjacent chambers of said plurality, so that the inflation of the entire packaging could be realized by feeding the fluid from a single point.

Advantageously, each of said chambers may have at least one pair of said conduits adapted to place the same in fluid communication with two distinct adjacent chambers of said plurality, so as to speed up the operations of inflation or filling.

Moreover, in this way the possible configurations obtainable from the same laminar element will be increased as the latter may be cut along different lines without affecting the continuity of the fluidic communication between the chambers.

Advantageously, each of said ducts may comprise a respective tubular element interposed between said layers at the localized connection areas, not joined with each other, of said edges and each having open ends in communication with respective adjacent chambers to be connected.

In this way the constant fluid connection between the chambers will be granted, avoiding that one or more ducts may be clogged and also simplifying the realization steps of the packaging.

Suitably, one or more of said tubular elements, possibly all, may include a respective one-way valve adapted to prevent the leakage of said fluid in a predetermined direction. In this way it will be avoided that the puncture of even a single chamber involves the partial or total emptying of the packaging.

Suitably, said flexible laminar element may present at least one longitudinal and/or transverse side susceptible to be cut to adjust the transverse and/or longitudinal dimension thereof and adapt it to the object to be packaged.

Advantageously, the fluidic connection means may include a tubular joint to be inserted in said inlet and possibly provided with universal means for connection to the external feeding means of the fluid.

In this way the operations of inflation of the chambers will be simplified because the joint could be connected to a common pump for bicycles, to a compressor, or may allow the simple oral inflation.

According to a further aspect of the invention a method is provided for realizing an inflatable packaging, which method comprises, according to claim 11, the steps of providing a flexible laminar element having a pair of layers, at least partial overlapping said layers, partially joining said layers by means of chemical and/or heat bonding at predetermined longitudinal and transverse connection lines to define a plurality of adjacent chambers adapted to be filled with a filling fluid.

The method is characterized in that for each of said connection lines at least one localized area is provided in which area said mutually overlapping layers are not joined together to define respective conduits for the fluidic communication between said chambers and to realize an inflatable packaging.

The method according to the invention will allow the packaging to be realized in a simple and quick manner, without the use of special equipment, further reducing costs. Advantageous embodiments of the packaging and of the corresponding method for its realization are obtained according to the dependent claims.

### BRIEF DISCLOSURE OF THE DRAWINGS

Further features and advantages of the packaging and of the method of the invention will become more apparent in light of the detailed description of some preferred but not limiting embodiments of the packaging, shown in way of a non-limiting example with the aid of the attached drawings wherein:

FIG. 1 is a front view of an inflatable packaging of the invention according a first embodiment and in a not inflated condition;

FIG. 2 is a front view of an inflatable packaging of the invention according a second embodiment and in a not inflated condition;

FIG. 3 is an enlarged and partially opened view of a particular of the packaging of FIG. 1;

FIG. 4 is a cross view of the packaging of FIG. 1;

FIG. 5 is an enlarged view of a further particular of a packaging of the invention in an inflated condition;

FIG. 6 is a front view of a packaging of the invention in a sequence for defining its dimensions;

FIG. 7 shows a sequence for realizing a packaging according the method of the present invention.

### BEST MODE FOR CARRYING OUT THE INVENTION

With reference to the above figures, an inflatable packaging according to the invention is shown, generally designated by 1, which packaging being designed to at least partially wrap one or more objects of any type, in order to protect the same during handling or transporting thereof.

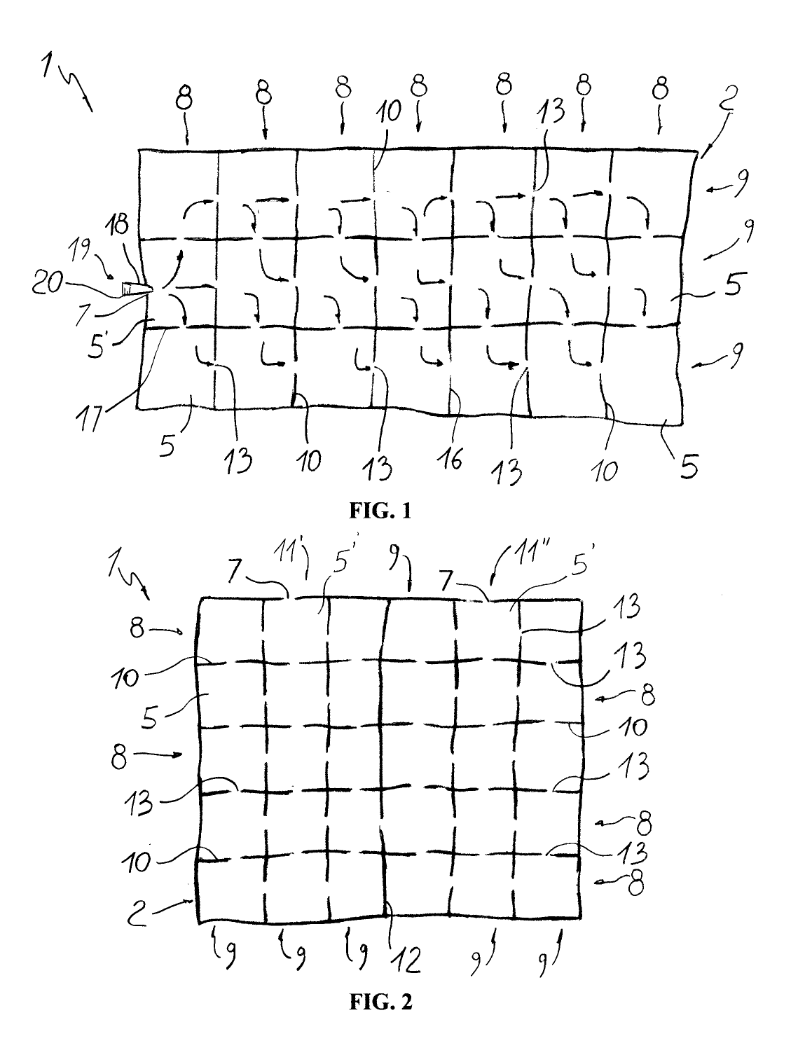

As shown in FIG. 1, the packaging 1 will essentially comprise a flexible laminar element 2 having at least one pair of mutually superimposed layers 3, 4 divided into a plurality of chambers, generally designated by 5, adapted to be filled with a filling fluid.

Although the packages of this type are generally designed to be filled with air, the choice of the filling fluid, liquid or gaseous, is solely entrusted to the final user and is therefore not absolutely limiting for the present invention.

Each single layer 3, 4 may be made of a material selected from the group comprising paper, cellulose-based materials, polymeric materials, such as polystyrene, polyurethanes, polyethylene, polyamides.

Preferably, polymeric materials may be used, such as high density polyethylene or nylon, for their strength and flexibility features, but the choice may be influenced also by the type of products to be packaged. For example in the case where it is necessary to pack foodstuffs you can use a material of suitable food grade.

Each layer 3, 4 may be defined by a single sheet of the respective material or may be a multilayer element in order to increase the strength.

Moreover, the laminar element 2 can be obtained starting from two distinct and separate sheets or from a same film folded back on itself with tails that will be overlapped with each other to define the respective layers 3, 4.

The packaging 1 also comprises means 6 for the mutual fluidic connection of the chambers 5 adapted to allow the flow circulation therebetween.

Further, at least one chamber 5′ is provided with an inlet 7 adapted to be connected to external means for supplying a filling fluid, not shown, so as to allow the simultaneous inflation or filling of all the chambers 5 through the inlet 7.

The single chambers 5, that once inflated or filled will define respective cushioning, could also be different in plan with each other, but preferably will be substantially equal to each other.

However, the plan dimensions of each chamber 5 do not represent a limitation for the present invention. Generally the chambers 5 will be quadrangular, for example square or rectangular, with longitudinal and transverse sides having length between 10 mm and 100 mm.

Moreover the cushions or chambers 5 may be arranged so as to be distributed along a plurality of longitudinal rows 8 and transverse columns 9 mutually orthogonal to each other.

The number of rows 8 and columns 9 from which the packaging 1 is initially formed is also a not essential aspect for the present invention. Moreover, as will appear more clearly hereinafter, two or more additional packaging 1′, 1″ of lower dimensions and not necessarily all equal can be obtained from a same packaging 1, by means of one or more cuts.

FIG. 1 shows a first embodiment for a packaging 1 according to the present invention formed from a single strip having three columns 9 of cushioning or chambers 5, wherein the mutually adjacent chambers 5 have an edge 10 in common and wherein all the chambers 5 are in fluidic communication therebetween.

Instead, FIG. 2 shows a second embodiment wherein the packaging 1 comprises a pair of strips 11′, 11″ substantially identical to each other joined at a longitudinal intermediate heat-sealed edge 12 and wherein the chambers 5 of a strips 11′ are not in fluidic communication with the chambers 5 of the other strip 11″.

In particular, along the intermediate heat-sealed edge 12 the aforesaid fluidic connection means 6 will not be provided for.

In a preferred manner, for each of the embodiments illustrated above the fluidic connection means 6 comprise a plurality of ducts 13 adapted to put in communication the mutually adjacent chambers 5.

In particular, each chamber 5 may present at least one pair of ducts 13 adapted to put the same in fluidic communication with two separate adjacent chambers 5 respectively belonging to the same row 8 and to the same column 9.

Preferably, at least the chambers 5 that are not arranged along the peripheral portion of the packaging 1 will present four conduits 13 so as to be placed in fluidic communication with all the chambers 5 having an edge 10 in common therewith, to speed up the inflating operations.

The mutually adjacent chambers 5 of each pair may have a transverse or longitudinal edge 10 in common, obtained by chemical bonding or, preferably, for hot die-cutting, to obtain the heat-sealing of the superimposed layers 3, 4 at longitudinal and transverse lines.

The fluidic communication ducts 13 may instead be positioned in correspondence of not reciprocally joined localized fluid connection areas of the edges 10.

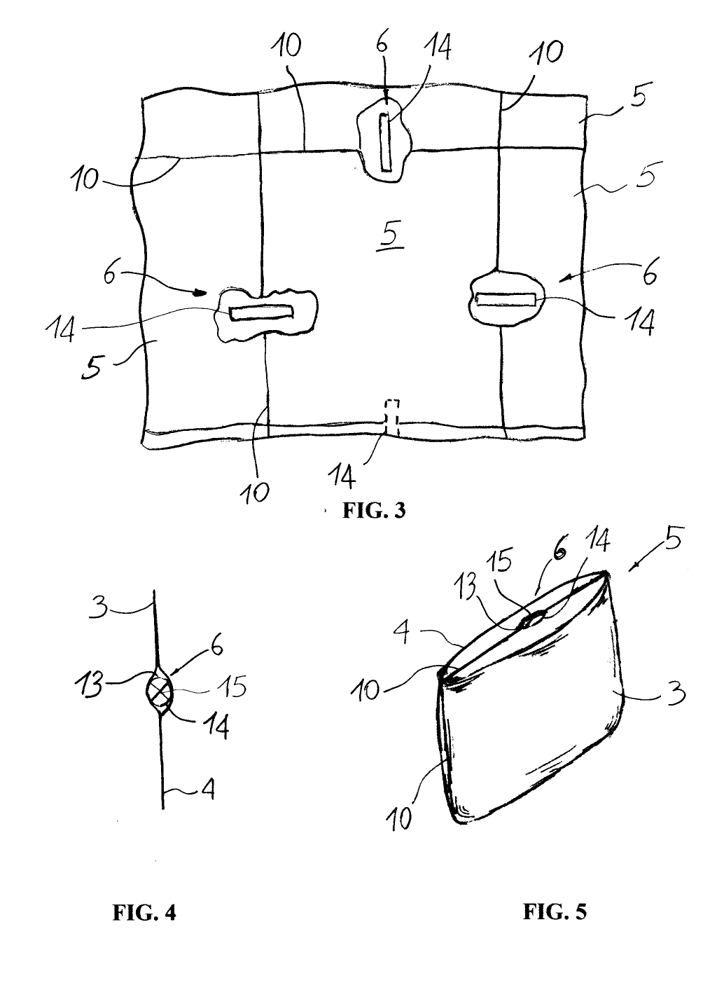

According to a preferred embodiment, more clearly shown from the detail of FIG. 3, each conduit 13 may comprise a tubular element 14 interposed between the superimposed layers 3, 4 in correspondence of the localized connection areas of the edges 10 and having opened ends in communication with respective adjacent chambers 5 to be connected.

The above tubular elements 14 will also aim to prevent the superimposed layers 3, 4 mutually join also at the localized areas necessary for the fluidic connection following the die-cutting.

The cross-section of FIG. 4 also shows that one or more tubular elements 14 may include one or more respective one-way retaining valves 15, arranged for example at one or both ends of the tubular element 14, and adapted to allow the fluid to flow only along a predetermined direction, as shown by the arrows in FIG. 1, and to avoid the leakage in the opposite direction.

The flexible laminar element 2 may have at least one longitudinal side 16 and/or transverse side 17 susceptible to be cut to adjust its transverse and/or longitudinal size and adapt it to the object to be packaged.

The fluidic connection means 6 may also comprise a tubular joint 18 adapted to be inserted in the inlet 7 and to be connect to external supplying means, for example by universal connection means 19.

For example, the joint 18 may be a cylindrical or frustoconical body having one end adapted to be inserted in the inlet 7 and the opposite end provided with a thread 20 suitable to its connection to a common pump typically used for inflating bicycle wheels or to connect to the air delivery duct of a compressor. Moreover, the joint 18 may be a simple tube for oral inflation.

The packaging 1 may also be provided with a series of joints different with each other and adapted to be selectively associated with different types of the above external feeding means.

FIG. 5 shows in turn a single chamber 5, wherein the fluidic connection means 6 are highlighted.

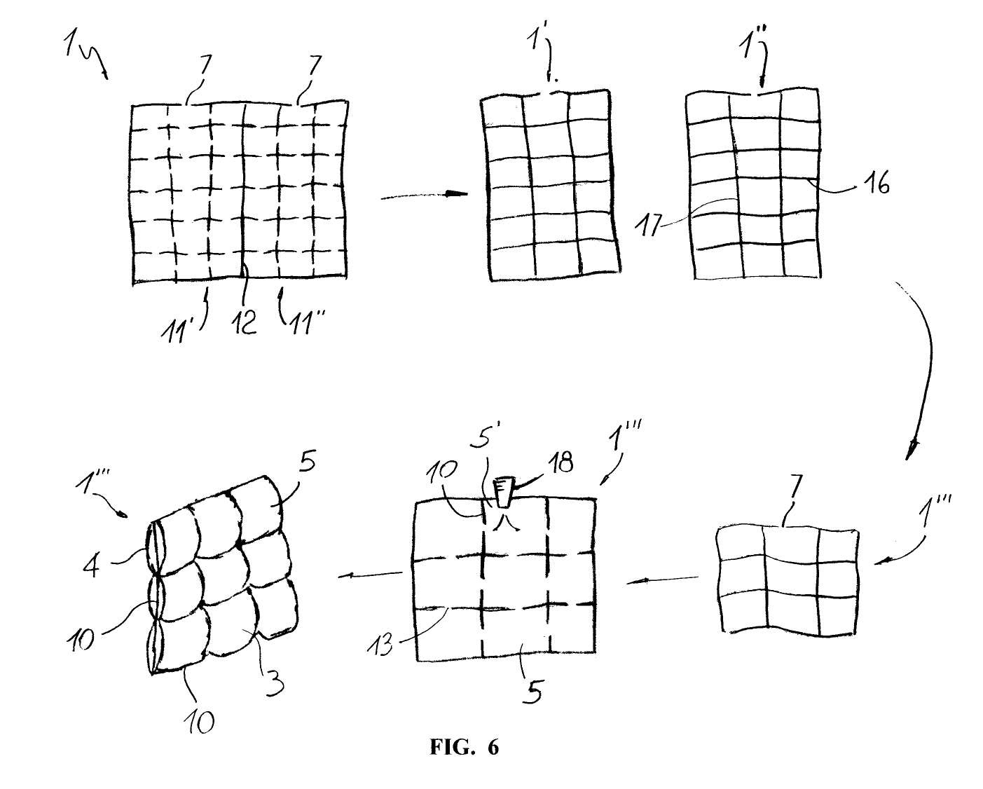

FIG. 6 shows a possible sequence of configuration of a packaging 1 according to the present invention.

In particular it could be observed that the initial packaging 1 may be formed by two or more contiguous strips 11′, 11″ whose respective chambers 5 are not in fluidic communication with each other.

Subsequently the two strips 11′, 11″, in which the fluidic connection means 6 are not shown for simplicity, will be divided to obtain two distinct packaging 1′, 1″, each of which may optionally be cut again to obtain one or more packages 1′″ having smaller dimensions appropriate to the specific product to be wrapped.

In particular, each of the above packaging 1′, 1″, 1″' may undergo one or more cuts along one or more longitudinal sides 16 and/or transverse sides 17.

However, after each cut it will be necessary to seal by any technique, for example by welding, capping, sticking, any fluid connection ducts 13 that will come to be arranged at the perimeter edges 21, with the exception of a duct that will define the inlet 7 for inserting the filling fluid.

Once the chambers 5 will have been inflated with the desired volume of fluid introduced through the inlet 7, it will be possible to seal the latter too, realizing the hermetic closure of the entire packaging 1′″ so that it will be ready for use.

Advantageously, the packaging 1 could be inflated directly by the end user just before being wrapped around one or more products to be protected or after being wrapped around the products in deflated condition, i.e. in the shape of flexible laminar element. Furthermore, it may be used alone or in combination with an additional outer container, for example a box made of paper, cardboard, metal or any other material.

If the packed product has to be placed inside a container the ability of inflating the single chambers 5 after the packaging 1 has been arranged around the products will allow the same chambers 5 to be inflated with different volumes of air or other fluid as the albeit limited elasticity of the materials used will allow the single chambers 5 to swell in function of the space inside the container.

Therefore, even in case of irregularly shaped products such as bottles, jars and the like, with broader areas and more narrow areas, which correspond to lower and greater gaps inside the outer container, the packaging 1 will always ensure the complete filling of these gaps, due to the particular flexibility of the single chambers 5, and then high protection and maximum stability of the products inside the container, even in case of strong shocks. Moreover this condition will be achieved in a much more simple, rapid and economic manner with respect of the known systems.

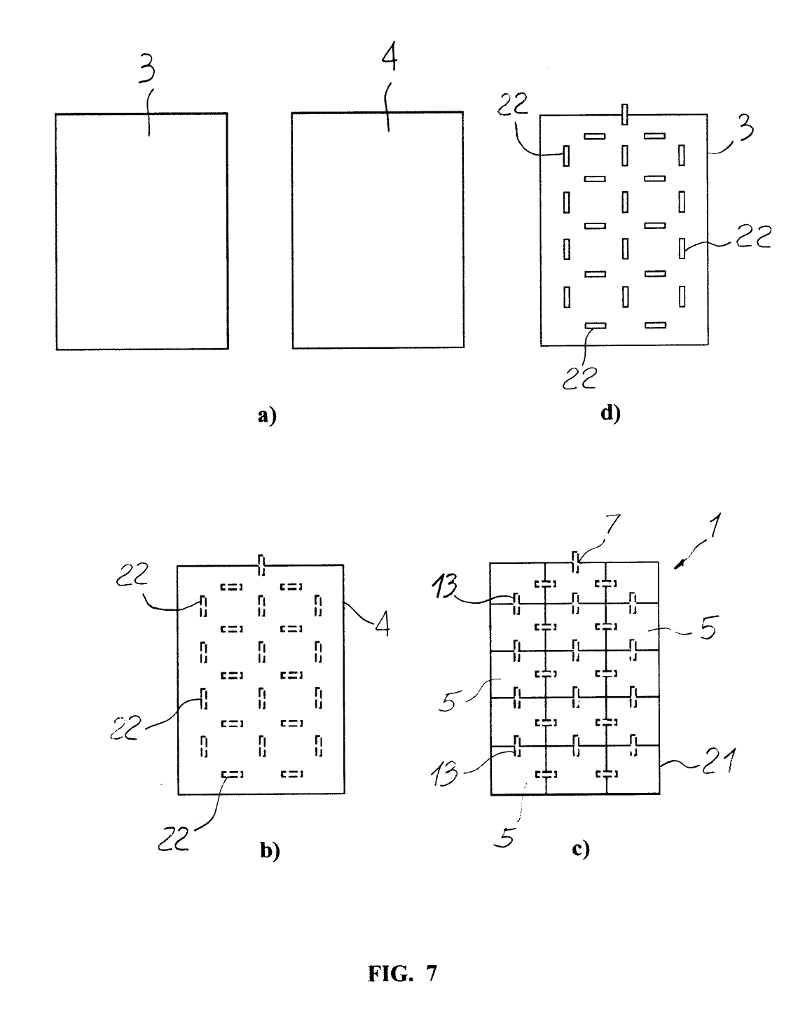

FIG. 7 schematically shows an exemplary sequence of a possible method for realizing inflatable packaging 1 according to the invention.

The method will include a step a) of providing a flexible laminar element 2 having a pair of layers 3, 4, that, as disclosed above, can be distinct or be defined by two tails of a same film.

Subsequently the layers 3, 4 will be at least partially overlapped (step b) and then partially joined with each other (step c) by means of chemical and/or heat bonding, for example by hot die, in correspondence of predetermined longitudinal and transverse connection lines to define a plurality of adjacent chambers 5 adapted to be filled with a filling fluid.

The connecting step c) will be carried out in such a manner that for each of the connecting lines at least one localized area will be provided in which the mutually overlapping layers 3, 4 are not joined together to define respective conduits 13 for fluidic communication of adjacent chambers 5.

In particular, before the step b) of overlapping a step d) may be provided for positioning a plurality of cylindrical cores 22 on one of the layers 3, 4, in particular on the layer 3 arranged below, to define the localized area for fluidic connection wherein the layers 3, 4 will not have to be mutually joined.

The cores 22 may be just the tubular elements 14 adapted to remain integrated within the layers 3, 4 for the fluidic connection of the adjacent chambers 5.

The method may comprise an optional step e) of cutting to size the inflatable packaging 1 so obtained and that should be carried out, of course, before the filling of the chambers 5 with the selected filling fluid.

From the above description, it is clear that the invention achieves the intended objects and in particular that of providing an inflatable packaging having reduced cost and encumbrance during both warehouse storage and transporting and which can also be configured in function of the shape and dimensions of the products to be packed even by the end user.

The packaging and the method disclosed above are susceptible of numerous modifications and variations. All the details may be replaced with other technically equivalent elements, and the materials may be different depending on the needs, without departing from the scope of the invention.

Although the packaging and its realization method have been disclosed with particular reference to the attached figures, reference numbers in the description and in the claims are used to improve the intelligence of the invention and do not constitute any limitation to the claimed scope of protection.

The invention claimed is:

1. An inflatable packaging, comprising:
a flexible laminar element (2) having at least one pair of mutually superimposed layers (3, 4) divided into a plurality of chambers (5) adapted to be filled with a filling fluid;
elements providing a mutual fluidic connection of said chambers (5), at least one chamber (5′) being provided with an inlet (7) adapted to be connected to an external line feeding said filling fluid inflating all of the chambers (5) of said plurality through said inlet (7).

2. The inflatable packaging as claimed in claim 1, wherein said chambers (5) are arranged along a plurality of longitudinal rows (8) and columns (9) orthogonal with each other.

3. The inflatable packaging as claimed in claim 1, wherein said fluidic connection elements (6) comprise a plurality of ducts (13) adapted to put into communication the mutually adjacent chambers (5) of said plurality.

4. The inflatable packaging as claimed in claim 3, characterized in that each of said chambers (5) has at least one pair of said ducts (13) adapted to put it into fluidic communication two different adjacent chambers (5) of said plurality.

5. The inflatable packaging as claimed in claim 3, each of said chambers (5) has longitudinal and transverse edges (10) obtained by joining said superimposed layers (3, 4) by chemical bonding or heat-sealing at longitudinal and transverse lines, said ducts (13) being arranged at localized fluidic connection areas of said edges (10) that are not reciprocally joined.

6. The inflatable packaging as claimed in claim 5, wherein each of said ducts (13) comprises a tubular element (14) interposed between said layers (3, 4) at said localized connection areas of said edges (10) and having opened ends in communication with adjacent chambers (5) to be connected.

7. The inflatable packaging as claimed in claim 6, wherein one or more of said tubular elements (14) comprises a one-way valve (15) adapted to avoid leakage of said filling fluid along a predetermined direction.

8. The inflatable packaging as claimed in claim 1, wherein said flexible laminar element (2) has one or both of a longitudinal side (16) and a transverse side (17) susceptible to be cut to adjust the transverse or longitudinal dimension of said flexible laminar element and adapt said flexible laminar element to an object to be packed therewith.

9. The inflatable packaging as claimed in claim 1, wherein said fluidic communication elements (6) comprise a tubular joint (18) adapted to be inserted into said inlet (7) and adapted to be connected to the external line feeding the filling fluid.

10. The inflatable packaging as claimed in claim 1, wherein said layers (3, 4) are made of a material selected from the group consisting of paper, cellulose-based materials, or polymeric materials.

11. A method of producing an inflatable packaging according to claim 1, comprising the following steps:
a) providing a flexible laminar element (2) having at least one pair of layers (3, 4);
b) at least partially overlapping said layers (3, 4); and
c) at least partially joining said layers (3, 4) by chemical bonding or hot-sealing along predetermined longitudinal and transverse connection lines to define a plurality of adjacent chambers (5) adapted to be filled with a filling fluid,
wherein each of said connection lines is provided with one or more localized areas wherein said overlapped layers (3, 4) are not joined with each other to define respective fluidic communication ducts (13) between said chambers (5) and produce an inflatable packaging.

12. The method as claimed in claim 11, further comprising, before said overlapping step b), a step of positioning a plurality of cylindrical cores (22) on one of said layers (3, 4) to define said localized areas wherein said layers (3, 4) are not joined with each other.

13. The method as claimed in claim 12, wherein said cylindrical cores (22) are tubular elements adapted to be integrated inside said layers (3, 4) for fluidic communication of adjacent chambers (5) of said plurality.

14. The method as claimed in claim 11, further comprising a size cutting step of said inflatable packaging (1), said size cutting step being carried out before filling said chambers (5) with the filling fluid.
